(19) United States
(12) Patent Application Publication
(10) Pub. No.: US 2025/0158212 A1
(43) Pub. Date: May 15, 2025

(54) SECONDARY BATTERY

(71) Applicant: SAMSUNG SDI CO., LTD., Yongin-si (KR)

(72) Inventors: Byung Min LEE, Yongin-si (KR); Sang Hun KIM, Yongin-si (KR); Hyeok Jun SEO, Yongin-si (KR); Su Bin BAE, Yongin-si (KR); Hyun Kyu KIM, Yongin-si (KR)

(21) Appl. No.: 18/636,400

(22) Filed: Apr. 16, 2024

(30) Foreign Application Priority Data
Nov. 9, 2023 (KR) 10-2023-0154342

(51) Int. Cl. H01M 50/342; H01M 50/103; H01M 50/15

(52) U.S. Cl. CPC H01M 50/3425; H01M 50/103; H01M 50/15

(57) ABSTRACT

A secondary battery includes an electrode assembly; a case accommodating the electrode assembly; and a cap plate coupled to an upper opening of the case, wherein the cap plate includes a vent, the vent including a vent hole passing through a central area of the cap plate and a vent plate coupled to the vent hole, the vent plate includes an upper vent plate fixed in position to an upper end of the cap plate; and a lower vent plate fixed in position to a lower end of the cap plate, and the upper vent plate and the lower vent plate are spaced apart from each other with an insulating layer therebetween.

### CROSS-REFERENCE TO RELATED APPLICATION

This application claims priority to and the benefit of Korean Patent Application No. 10-2023-0154342, filed on Nov. 9, 2023, in the Korean Intellectual Property Office, the disclosure of which is incorporated herein by reference in its entirety.

### BACKGROUND

### 1. Field

Embodiments relate to a secondary battery.

### 2. Description of the Related Art

A secondary battery, unlike a primary battery, is a battery that is repeatedly chargeable and dischargeable.

Small-capacity secondary batteries may be used in small and portable electronic devices such as mobile phones, laptop computers, and camcorders, and high-capacity secondary batteries may be used as power sources for driving motors in hybrid vehicles and electric vehicles. A secondary battery may include an electrode assembly that performs a charging/discharging operation, a case that accommodates the electrode assembly, a cap plate coupled to an opening of the case, and an electrode terminal that withdraws the electrode assembly to the outside of the cap plate.

The above-described information disclosed in the technology that serves as the background of the present disclosure is only for improving understanding of the background of the present disclosure and thus may include information that does not constitute the related art.

### SUMMARY

The embodiments may be realized by providing a secondary battery including an electrode assembly; a case accommodating the electrode assembly; and a cap plate coupled to an upper opening of the case, wherein the cap plate includes a vent, the vent including a vent hole passing through a central area of the cap plate and a vent plate coupled to the vent hole, the vent plate includes an upper vent plate fixed in position to an upper end of the cap plate; and a lower vent plate fixed in position to a lower end of the cap plate, and the upper vent plate and the lower vent plate are spaced apart from each other with an insulating layer therebetween.

The insulating layer may include a heat-resistant polymer layer between the upper vent plate and the lower vent plate.

The polymer layer may be made of engineering plastic.

The insulating layer between the upper vent plate and the lower vent plate may be a vacuum.

A thickness of each of the upper vent plate, the lower vent plate, and the insulating layer may be about 0.3 mm to about 0.8 mm.

Each of the upper vent plate and the lower vent plate may have a planar oval shape.

Each of the upper vent plate and the lower vent plate may include a notch, and each notch may have a thickness that is less than that of the upper vent plate and the lower vent plate around the notch.

### BRIEF DESCRIPTION OF THE DRAWINGS

Features will be apparent to those of skill in the art by describing in detail exemplary embodiments with reference to the attached drawings in which:

FIG. 1 illustrates a perspective view of a secondary battery according to embodiments;

FIG. 2 illustrates a cross-sectional view of FIG. 1;

FIG. 3 illustrates an enlarged view of a vent of FIG. 1;

FIGS. 4A and 4B illustrate enlarged conceptual views of the vent; and

FIG. 5 illustrates an enlarged cross-sectional view of the vent in the secondary battery according to embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or element, it can be directly on the other layer or element, or intervening layers may also be present. In addition, it will also be understood that when a layer is referred to as being “between” two layers, it can be the only layer between the two layers, or one or more intervening layers may also be present. Like reference numerals refer to like elements throughout.

Also, the expressions “comprise,” “include,” “comprising,” and/or “including” used in this specification neither define the mentioned shapes, numbers, steps, operations, members, elements, and/or groups of these, nor exclude the presence or addition of one or more other different shapes, numbers, steps, operations, members, elements, and/or groups of these, or addition of these. The terms “or” and “and/or” used herein are not exclusive terms and include any and all combinations of one or more of the associated listed items.

The reference to two objects of comparison being ‘the same’ means ‘substantially the same’. Therefore, substantially identical may include a deviation that is considered to a low level, e.g., a deviation of less than 5%. In addition, uniformity of a parameter on a certain area may mean uniformity from an average perspective.

It will be understood that although the terms of first and second are used herein to describe various elements, these elements should not be limited by these terms. These terms are only used to distinguish one component from another component, and unless specifically stated to the contrary, the first component may also be a second component, and are not intended to imply or require sequential inclusion.

Throughout this specification, unless specifically referred to the contrary, each component may be singular or plural.

An arrangement of any component on an “upper portion (or lower portion)” of a component or on a top (or bottom) of a component means that any component is placed in contact with a top surface (or bottom surface of the component, as well as other elements are interposed between the element and any element disposed above (or below) the element.

In addition, if a component is described as being “linked”, “coupled”, or “connected” to another component, it should be understood that the above components may be directly connected or connected to each other, but other components may be “interposed” between each component, or each component may be “linked”, “coupled”, or “connected” through another component. Also, in this specification below, if any portion is referred to as being “electrically connected” to another portion, it should be understood that the former can be “directly connected” to the latter, or “connected” to the latter via an intervening member.

If referring to “A and/or B” throughout the specification, this means A, B or A and B, unless specifically stated to the contrary. That is, “and/or” includes all or any combination of the plurality of listed items. If referring to “C to D”, this means not less than C and not more than D, unless otherwise specified.

The terms used in this specification are for describing embodiments of the present disclosure and are not intended to limit the disclosure.

In some embodiments of the [cylindrical/prismatic/pouch]-type battery according to an embodiment of the present disclosure, one of the prismatic/pouch/circular batteries is selected, and the selected battery is described as having a general structure, and for commonly applied technologies, describe the general structure of prismatic/pouch/round cells.

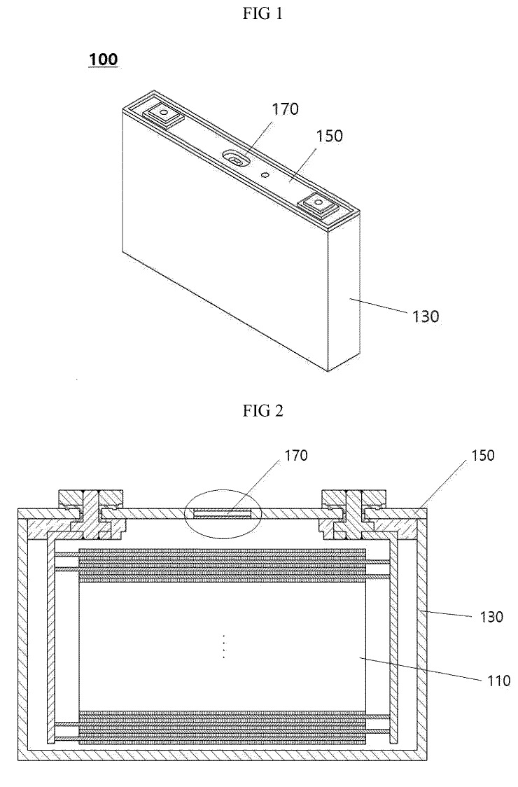

FIG. 1 illustrates a perspective view of a secondary battery according to embodiments, and FIG. 2 illustrates a cross-sectional view of FIG. 1. As illustrated in FIGS. 1 and 2, a secondary battery 100 according to embodiments may include an electrode assembly 110, a case 130, and a cap plate 150.

The electrode assembly 110 may be provided by winding or stacking a stack of a first electrode plate, a separator, and a second electrode plate, each of which is provided in a thin plate or film shape. In an implementation, the electrode assembly 110 may be a rolled stack, and a winding axis may be parallel to a longitudinal direction y of the case 130. In an implementation, the electrode assembly 110 may be a stack type rather than a winding type. In an implementation, the electrode assembly 110 may include a Z-stack electrode assembly 110 in which a positive electrode plate and a negative electrode plate are inserted into both sides of the separator that is bent in the form of a Z-stack. In an implementation, the electrode assembly 110 may be stacked so that one or more electrode assemblies 110 are adjacent to each other and accommodated in the case 130. In an implementation, a number of electrode assemblies 110 may vary. In an implementation, the first electrode plate of the electrode assembly 110 may serve as a negative electrode, and the second electrode plate may serve as a positive electrode. In an implementation, the first electrode plate may serve as a negative electrode, and the second electrode plate may serve as a positive electrode.

The first electrode plate may be formed by applying a first electrode active material, e.g., graphite or carbon, to a first electrode current collector plate made of a metal foil, e.g., copper, a copper alloy, nickel, or a nickel alloy, and may include a first electrode tab (or first non-coating portion) that is not coated with the first electrode active material. The first electrode tab may serve as a path for a current flow between the first electrode plate and a first current collector. In an implementation, the first electrode tab may be formed by being cut in advance to protrude to one side if the first electrode plate is manufactured and may protrude more to one side than a separator without separate cutting.

The second electrode plate may be provided by applying a second electrode active material, e.g., a transition metal oxide, to a second electrode current collector plate made of metal foil, e.g., aluminum or an aluminum alloy, and may include a second electrode tab (or second non-coating portion) that is not coated with the second electrode active material. The second electrode tab may be a passage through which current flow between the second electrode plate and a second current collector. In an implementation, the second electrode tab may be provided by being cut in advance to protrude to the other side if the second electrode plate is manufactured and may protrude more to the other side than the separator without separate cutting.

In an implementation, the first electrode tab may be on a side surface of a left end of the electrode assembly 110, and the second electrode tab may be on a side surface of a right end of the electrode assembly 110 or on one surface in the same direction. Here, the left and right sides are for convenience of explanation based on the secondary battery 100 illustrated in FIG. 1, and the position of the secondary battery 100 may be changed if the secondary battery 100 rotates left and right or up and down.

A first electrode tab of the first electrode plate and a second electrode tab of the second electrode plate may be on both ends of the electrode assembly 110 as described above, respectively. In an implementation, the electrode assembly 110 may be accommodated in the case 130 together with the electrolyte. In an implementation, in the electrode assembly 110, the first current collector and the second current collector may be welded and connected to the first electrode tab of the first electrode plate and the second electrode tab of the second electrode plate, which are exposed to both the sides, respectively.

The case 130 may accommodate the electrode assembly 110. In an implementation, the case 130 may have a substantially rectangular parallelepiped shape to set a space for accommodating the electrode assembly 110 and the electrolyte therein, and an opening connecting external and internal spaces to each other may be defined in one surface of a rectangular parallelepiped. The opening may allow the electrode assembly 110 to be inserted into the case 130.

In an implementation, the case 130 may be provided in various shapes such as a circular shape or a pouch shape. In an implementation, the case 130 may be made of a metal such as aluminum, aluminum alloy, or nickel-plated steel, or a laminated film or plastic that constitutes the pouch.

The cap plate 150 may be installed in the opening of the case 130 to seal the opening of the case 130. In an implementation, the case 130 and the cap plate 150 may be made of aluminum and welded to each other.

In an implementation, the cap plate 150 may further include a terminal hole and an electrolyte injection port. The electrolyte injection port may allow the electrolyte to be injected into the case 130 after coupling and welding the cap plate 150 to the case 130.

Negative and positive terminals may be electrically and mechanically connected to the electrode assembly 110 and installed in the terminal holes of the cap plate 150. In an implementation, the negative and positive terminals may be electrically connected to the negative and positive terminals of the electrode assembly 110, respectively. In an implementation, the electrode assembly 110 may be withdrawn to the outside of the case 130 through the negative and positive terminals.

The vent part or vent 170 may be defined in a central area of the cap plate 150. A high-temperature gas and pressure, which may be generated inside the case 130, may be discharged to the outside of the case 130 through the vent 170. In an implementation, the vent 170 may include a vent hole 171 (passing through the central region of the cap plate 150) and a vent plate (sealed and coupled to the vent hole 171). The vent plate may seal the vent hole 171 and be installed so that if a cell event were to occur, the vent plate could be broken to discharge the internal pressure of the secondary battery 100. In an implementation, the internal pressure may reach a set pressure, and the vent plate may be cut or burst to open the vent hole 171. The vent plate may have a notch that guides the cutting or bursting.

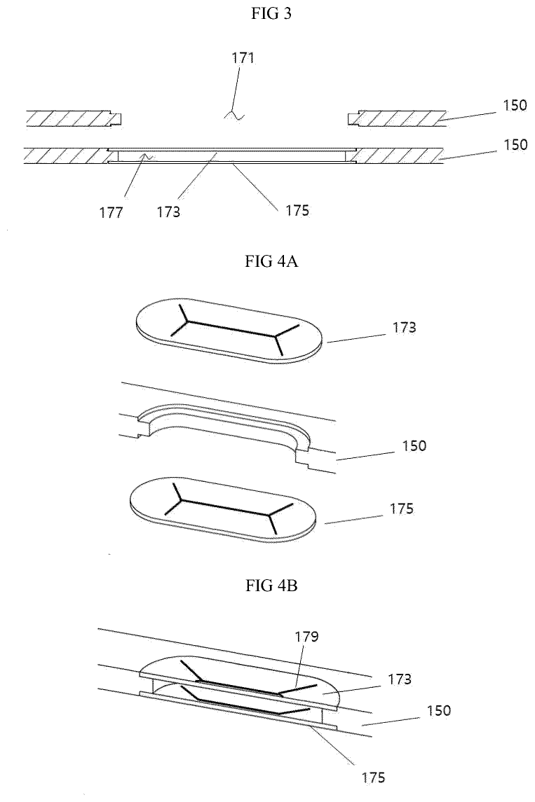

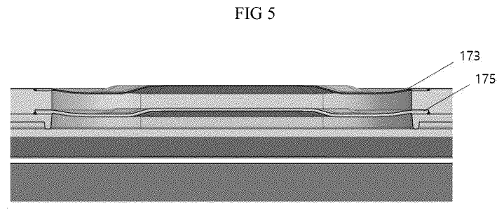

FIG. 3 illustrates an enlarged view of the vent of FIG. 1, FIGS. 4A and 4B illustrate enlarged conceptual views of the vent, and FIG. 5 illustrates an enlarged cross-sectional view of the vent in the secondary battery according to embodiments. The secondary battery 100 according to embodiments may have a double vent structure in which the above-described vent 170 includes an insulating layer therebetween. Hereinafter, the vent structure will be described in more detail with reference to FIGS. 3 to 5.

The vent 170 according to embodiments may include a vent hole 171 and a vent plate. The vent plate may include an upper vent plate 173 (fixed in position to an upper end of the cap plate 150) and a lower vent plate 175 (fixed in position to a lower end of the cap plate 150). In an implementation, the upper vent plate 173 and the lower vent plate 175 may be spaced apart from each other to define a space therebetween. This space may provide or accommodate an insulating layer. In an implementation, this space may be in a vacuum state, e.g., may be a vacuum.

The upper vent plate 173 and the lower vent plate 175 may have substantially the same shape and may have an elliptical planar shape (e.g., a planar oval shape) as illustrated in the drawings. In an implementation, each of the upper vent plate 173 and the lower vent plate 175 may include a notch part or notch 179, and a thickness of the notch 179 may be thinner than that of a plate around the notch 179. In an implementation, a high-temperature and high-pressure gas could be generated inside the cell, and the thinner notch 179 may be broken first if a pressure of the gas were to exceed a preset threshold.

A pair of vent plates configured as described above may be on the cap plate 150 to be spaced apart from each other in the vertical direction and then may be fixed to be sealed. The vent hole 171 may pass through the cap plate 150, and a concave stepped portion may be provided along a circumference of the vent hole 171 on each of top and bottom surfaces of the cap plate 150 to seat the vent plate. The pair of vent plates may seal the top and bottom surfaces of the vent hole 171 in the cap plate 150, and the insulating layer therebetween may be set to the vacuum state.

In an implementation, the vent plate may be designed with the double structure, the original gas discharge function of the vent part may be performed as it is, and the cell may be protected by preventing the vent 170 from being damaged even if ignition were to occur in an adjacent cell. In an implementation, the lower vent plate 175 may be exposed to the internal space of the case 130 and may be configured to be opened by breaking the notch 179 if the high-pressure gas generated inside the cell exceeds a preset critical pressure. In an implementation, the lower vent plate 175 may withstand a pressure of about 10 kgf/cm² to about 15 kgf/cm² and may be designed so that the notch 179 is broken in a range exceeding the above-described pressure. In an implementation, the upper vent plate 173 may be configured to be opened by breaking the notch 179 if the high-pressure gas inside the cell were to exceed the preset critical pressure. In an implementation, the upper vent plate 173 may be configured to withstand a pressure of about 5 kgf/cm² to about 7 kgf/cm² and may be designed so that the notch 179 is broken in a range exceeding the above-described pressure. This may occur if both the lower and upper vent plates 173 are broken. The gas inside the cell may be discharged to the outside through the vent hole 171.

In an implementation, the upper vent plate 173 may be exposed to the outside of the case 130 and may have a function of blocking flame from entering the cell if the flame were to reach the cap plate 150 due to an event occurring in an adjacent cell.

The preventing of the heat propagation may be an important feature in modules or packs for vehicles. If the battery module or pack were to fail to block the heat propagation, the event cell could explode and emit flame, and thus, the flame could spread through the passage to heat the adjacent cells. In an implementation, the most vulnerable portion of the cell may be the thin vent part, and if the vent part were to be exposed to the flame, the vent part may be melted to cause leaks, which is capable of leading to ignition of the flammable electrolyte.

In an implementation, the upper vent plate 173 may be provided separately from the lower vent plate 175. In an implementation, an insulating layer may be provided between the two vent plates, and thus, the lower vent plate 175 may not be directly affected by the flame even if exposed to the flame. The lower vent plate 175 may fundamentally perform an important function of preventing the cell explosion by being broken in advance to discharge the gas if the gas pressure inside the cell were to exceed a reference value. In an implementation, it may be important to be smoothly broken under design conditions. If the vent plate were to be broken due to an influence of the temperature or pressure during the occurrence of the flame outside the cell, the explosion inside the cell could occur due to the external factors. In order to prevent this phenomenon, the cell may be prevented from being directly affected by the flame.

In an implementation, the upper vent plate 173 may be provided separately from the lower vent plate 175. The upper vent plate 173 may previously undergo an experience of the high temperature and high pressure environment outside the cell to suppress the introduction of the flame into the cell.

In an implementation, the insulating layer 177 between the double vent plates may be in the vacuum state. In an implementation, the vacuum insulating layer 177 may have the insulation function, and thermal conduction may be suppressed even if the insulating layer 177 were to be exposed to the high-temperature heat. In an implementation, the insulating layer may help protect the lower vent plate 175 below the insulating layer 177 from the influence of the flame. In an implementation, the insulating layer 177 may be prepared in the vacuum state, and the thermal conductivity may be maintained at about 0.002 W/m·K or less.

According to another embodiment, a heat-resistant polymer layer may be the insulating layer 177 between the above-described upper vent plate 173 and lower vent plate 175. In an implementation, the polymer layer may be manufactured using engineering plastic. The engineering plastic may be high-performance plastic that is capable of replacing a metal and may have excellent strength, impact resistance, abrasion resistance, cold resistance, and chemical resistance, and, e.g., excellent heat resistance. In an implementation, polyamide (PA), polycarbonate (PC), polyethylene (PE), polypropylene (PP), polyimide (PI), polystyrene (PS), or the like may be used as the engineering plastic. The heat-resistant polymer layer (instead of the vacuum state) may be the insulating layer 177, and thus, the lower vent plate 175 may be protected from high-temperature flame. A thickness of each of the upper vent plate 173, the lower vent plate 175, and the insulating layer 177 may be, e.g., about 0.3 mm to about 0.8 mm.

By way of summation and review, a vent part or vent may be in the cap plate of the secondary battery. In the vent, a vent plate may be coupled to a vent hole in the case. The vent plate may have a thin thickness, and if an internal pressure of the case were to increase due to overcharging, the vent plate could be preferentially broken than other portions to discharge a high-temperature gas and pressure to the outside, thereby securing safety of the secondary battery.

In a battery module or battery pack, the vent in an individual cell may be vulnerable to external heat, and thus, there could be a limitation in that the vent could be melted if an event were to occur in an adjacent cell. That is, if an event were to occur in a specific cell in a battery module/pack, and flame were to be exploded, the adjacent cell could be heated. The vent, which may be the most vulnerable portion to heat in the cell structure, could be melted due to the heating, which is capable of causing leaks in the cell. This could lead to ignition of a flammable electrolyte inside the cell, and thus, there may be a risk of serial explosion in the adjacent cell. Thus, a secondary battery including constituents which are capable of improving stability is required.

According to the present disclosure, the spaced space between the double vent plates may be provided as the insulating layer, and even if the vent plate were to be exposed to external high-temperature heat, the heat conduction may be suppressed to help protect the lower vent plate below the insulating layer against the influence of the flame.

According to the present disclosure, the insulating layer having the double vent part structure, i.e., the upper and lower vent part structure, may be designed in the vacuum state to help prevent the heat from being transferred to the lower vent plate even if the upper vent plate were to be exposed to the high-temperature heat, thereby providing the effect of blocking the ignition of the electrolyte.

One or more embodiments may provide a secondary battery having a vent structure, which may be capable of blocking heat propagation into a cell if the heat propagation to the outside of an individual cell were to occur due to an event in an adjacent cell in a battery module/pack.

Example embodiments have been disclosed herein, and although specific terms are employed, they are used and are to be interpreted in a generic and descriptive sense only and not for purposes of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A secondary battery, comprising:
an electrode assembly;
a case accommodating the electrode assembly; and
a cap plate coupled to an upper opening of the case,
wherein:
the cap plate includes a vent, the vent including a vent hole passing through a central area of the cap plate and a vent plate coupled to the vent hole,
the vent plate includes:
an upper vent plate fixed in position to an upper end of the cap plate; and
a lower vent plate fixed in position to a lower end of the cap plate, and
the upper vent plate and the lower vent plate are spaced apart from each other with an insulating layer therebetween.

2. The secondary battery as claimed in claim 1, wherein the insulating layer includes a heat-resistant polymer layer between the upper vent plate and the lower vent plate.

3. The secondary battery as claimed in claim 2, wherein the polymer layer is made of engineering plastic.

4. The secondary battery as claimed in claim 1, wherein the insulating layer between the upper vent plate and the lower vent plate is a vacuum.

5. The secondary battery as claimed in claim 1, wherein a thickness of each of the upper vent plate, the lower vent plate, and the insulating layer is about 0.3 mm to about 0.8 mm.

6. The secondary battery as claimed in claim 1, wherein each of the upper vent plate and the lower vent plate has a planar oval shape.

7. The secondary battery as claimed in claim 1, wherein:
each of the upper vent plate and the lower vent plate includes a notch, and
each notch has a thickness that is less than that of the upper vent plate and the lower vent plate around the notch.
